(19) United States
(12) Patent Application Publication
(10) Pub. No.: US 2016/0141674 A1
(43) Pub. Date: May 19, 2016

(54) FUEL CELL SYSTEM AND METHOD OF RECOVERYING CELL VOLTAGE THEREOF

(71) Applicant: TOYOTA JIDOSHA KABUSHIKI KAISHA, Toyota-shi (JP)

(72) Inventors: Satoshi Shiokawa, Toyota-shi (JP); Tetsuya Bono, Toyota-shi (JP); Osamu Hamanoi, Toyota-shi (JP)

(73) Assignee: TOYOTA JIDOSHA KABUSHIKI KAISHA, Toyota-shi (JP)

(21) Appl. No.: 14/923,927

(22) Filed: Oct. 27, 2015

(30) Foreign Application Priority Data
Nov. 14, 2014 (JP) 2014-231451

(51) Int. Cl. H01M 8/04; H01M 8/24

(52) U.S. Cl. CPC H01M 8/04492; H01M 8/04753; H01M 8/04544; H01M 8/24; H01M 8/04925; H01M 2250/20

(57) ABSTRACT

An amount of power generation is increased in the case where a difference in water content between some and others of the cells is greater than a predetermined value. In the case of satisfaction of a first condition that the difference in water content between some and others of the cells is greater than the predetermined value, a fuel battery may be caused to perform an operation in which the amount of power generation exceeds that in the normal operation to reduce a cell voltage difference ΔV between an average cell voltage Va and a minimum cell voltage Vb. The first condition is, for example, that the cell voltage difference ΔV, which is a difference between the average cell voltage Va and the minimum cell voltage Vb, is greater than a first threshold value.

### BACKGROUND

1. Field

The present disclosure relates to recovery control in the case of a drop of cell voltage in a fuel cell system including a fuel battery composed of a plurality of cells.

2. Background Art

Excessive accumulation of water in cells constituting a fuel battery causes a drop of cell voltage due to suppression of the supply of reactant gas or the like. Therefore, in the case of a drop of the voltage of some of a plurality of cells constituting a fuel battery or in the case where the drop is predicted, water excessively accumulated in the cells is discharged by blowing an oxidizing gas (hereinafter, also referred to as “air blow” in this specification) to stabilize the cell voltage (see, for example, JP2006-294402 A).

### SUMMARY

In the case where a water content difference between cells is large, however, it is sometimes difficult to discharge water effectively even by means of the air blow. Specifically, even if the air blow is performed in a state where a water content difference between stacked cells is large, water is hardly discharged in cells having high water content (in other words, cells requiring the discharge of water, which normally correspond to cells at the ends of the cell stack and cells in the vicinity thereof) due to high pressure loss (consumption of energy such as pressure of a fluid or the energy consumption amount thereof, caused by the shape of a fluid flow path, the smoothness of a surface of the fluid flow path, water accumulating on the fluid flow path and blocking the flow, or the like) and due to difficulty in air flow. On the other hand, in cells having low water content with low pressure loss, air easily flows and water is excessively discharged. Therefore, a sufficient discharge effect cannot be achieved only by the aforementioned air blow in a state of a large water content difference, thereby sometimes causing a cell voltage drop again in a short time after the air blow.

Therefore, it is an object of the present disclosure to provide a fuel cell system and a method of recovering a cell voltage thereof capable of recovering a dropped voltage by sufficiently discharging water even in the case where a water content difference is large between stacked cells and air is hardly flows in some of the cells.

In order to achieve the above-mentioned object, there is provided a fuel cell system including a fuel battery composed of a plurality of cells, the fuel cell system including cell voltage recovery unit configured to increase an amount of power generation in the case where a difference in water content between some and others of the cells is greater than a predetermined value.

Upon increase in the amount of power generation, the flow rate of a fuel gas and that of an oxidizing gas are also increase according to the increased current, thereby generating much water. This increases the water content of some cells (normally, the central cells close to the center of the cell stack). Meanwhile, water collects in other cells (normally, cells at the ends of the cell stack and cells in the vicinity thereof) and power is hardly generated, and therefore the water content of other cells is nearly unchanged. Accordingly, the difference in water content between some and others of the cells is reduced and thus a pressure loss difference is reduced, by which water is easily discharged. Since water is easily discharged, the water excessively accumulated in the cells totally decreases and the dropped cell voltage recovers.

The cell voltage recovery unit may cause the fuel battery to perform operation in which the amount of power generation increases to be a threshold value or more and the amount of power generation exceeds that in the normal operation in the case where a first condition is satisfied such that the difference in water content between some and others of the cells is greater than the predetermined value.

The first condition may be that a cell voltage difference ΔV, which is a difference between an average cell voltage Va and a minimum cell voltage Vb, is greater than a first threshold value. The cell voltage difference ΔV is detected in this manner, by which the state of the cell water content can be grasped.

The cell voltage recovery unit is able to stop cell voltage recovery control in the case where the cell voltage difference ΔV between the average cell voltage Va and the minimum cell voltage Vb decreases to the first threshold value or less after satisfying the first condition and then a state where the cell voltage difference ΔV is smaller than a second threshold value, which is smaller than the first threshold value, has continued for a predetermined time or longer. The state where the cell voltage difference ΔV is smaller than the second threshold value, which is smaller than the first threshold value, is specifically a state where the cell voltage has recovered to some extent. Therefore, wasteful power generation can be suppressed after the completion of the voltage recovery process by stopping the cell voltage recovery control at the time when the predetermined time has passed from the time point of achieving the state.

Moreover, the first condition may be that a difference in water content between end cells and central cells obtained by calculation is greater than a predetermined value. In the fuel battery, the water content of the end cells of the cell stack is apt to be excessive. Therefore, it is possible to determine whether to perform the cell voltage recovery process from the difference in water content between the end cells and the central cells.

The cell voltage recovery unit may increase the flow rate of the oxidizing gas in synchronization with increasing the amount of power generation. This enables the discharge amount of water to increase. Moreover, the increase in the flow rate of the oxidizing gas enhances a purge effect of the fluid.

Furthermore, according to the present disclosure, there is provided a method of recovering a cell voltage of a fuel cell system including a fuel battery composed of a plurality of cells, including the step of increasing an amount of power generation in the case where a difference in water content between some and others of the cells is greater than a predetermined value.

In this recovery method, the fuel battery may be caused to perform operation in which the amount of power generation exceeds that in the normal operation in the case where a first condition is satisfied such that the difference in water content between some and others of the cells is greater than the predetermined value to reduce a cell voltage difference ΔV between an average cell voltage Va and a minimum cell voltage Vb.

Further, there is provided a fuel cell system comprising:

a fuel cell which has a plurality of cells;

a cell monitor which detects cell voltage of the cells; and

a control device, wherein the control device comprises:
a cell voltage determination unit configured to determine whether a voltage difference between an average voltage of the cells and a minimum cell voltage Vb of the cells, which has been detected by the cell monitor, has reached a predetermined threshold value or greater;
an output current control unit configured to perform power generation of a predetermined value or greater so that a water content difference between the cells is reduced in the case where the cell voltage determination unit determines that the voltage difference between the average voltage of the cells and the minimum cell voltage Vb of the cells is equal to or greater than the predetermined threshold value; and
an air flow rate increase processor unit configured to perform an increase process of the air flow rate of the fuel cell so that the water content difference between the cells in synchronization with an increase in power generation is reduced in a case where the cell voltage determination unit determines that the voltage difference between the average voltage of the cells and the minimum cell voltage Vb of the cells is equal to or greater than the predetermined threshold value.

### BRIEF DESCRIPTION OF THE DRAWINGS

FIG. 1 is a diagram schematically illustrating a configuration example of a fuel cell system;

FIG. 2 is a block diagram illustrating an example of a functional configuration of a control unit;

FIG. 3 is a diagram illustrating an outline of a state where a large difference is observed in water content between stacked cells;

FIG. 4 is a diagram illustrating an outline of the water contents of the cells after a cell voltage recovery process;

FIG. 5 is a graph illustrating an average cell voltage Va, a minimum cell voltage Vb, threshold values, and the like in the cell voltage recovery process;

FIG. 6 is a first flowchart illustrating an example of the cell voltage recovery process; and

FIG. 7 is a second flowchart illustrating an example of the cell voltage recovery process.

### DESCRIPTION OF THE PREFERRED EMBODIMENTS

Hereinafter, preferred embodiments of a fuel cell system according to the present disclosure will be described with reference to the accompanying drawings. In the embodiments described below, description will be made on a case where the fuel cell system is used as an in-vehicle power generation system of a fuel cell hybrid vehicle (FCHV). The fuel cell system according to the present disclosure is also applicable to various mobile bodies (a robot, a vessel, an aircraft, etc.) other than the fuel cell hybrid vehicle and further applicable to a stationary power generation system used as power generation facilities for premises (dwellings, buildings, etc.).

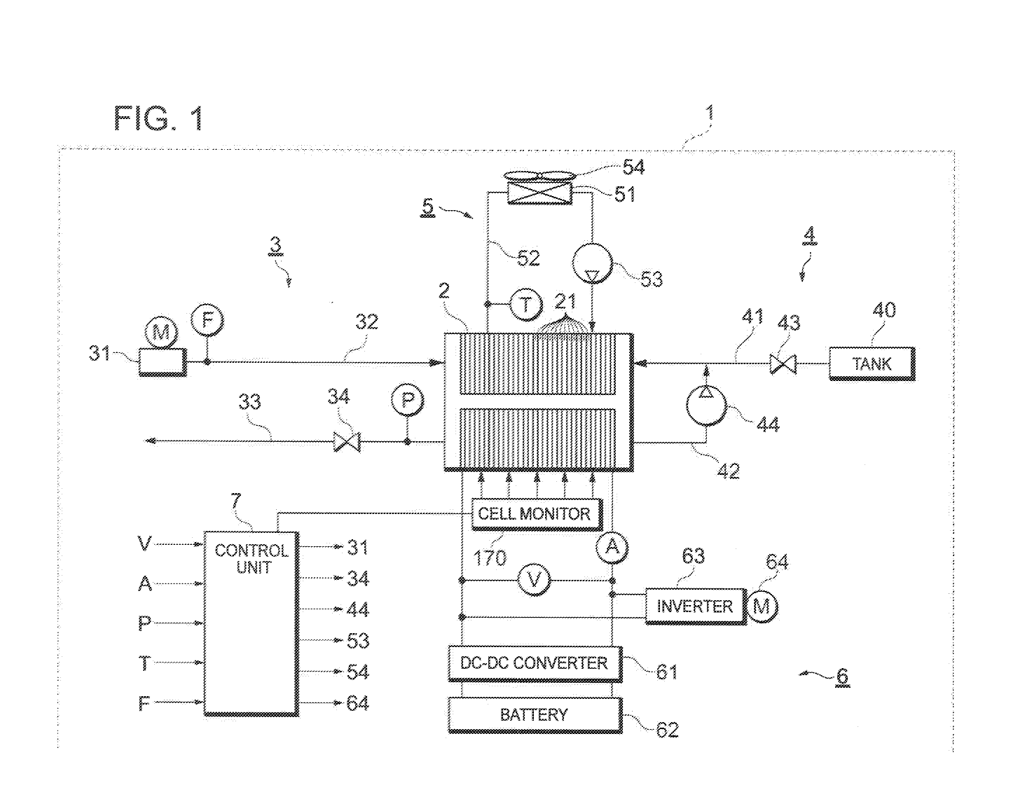

First, referring to FIG. 1, description will be made on the configuration of a fuel cell system according to this embodiment. FIG. 1 is a configuration diagram schematically illustrating a fuel cell system in this embodiment.

A fuel cell system 1 has a fuel battery 2 which generates electric power by an electrochemical reaction upon receipt of supply of an oxidizing gas and a fuel gas, which are reactant gases, an oxidizing gas piping system 3 which supplies the fuel battery 2 with air as the oxidizing gas, a fuel gas piping system 4 which supplies the fuel battery 2 with hydrogen as the fuel gas, a cooling system 5 which supplies cooling water to the fuel battery 2 in a circulating manner, an electric power system 6 which charges and discharges electric power to and from the system, and a control unit 7 which integrally controls the entire system.

The fuel battery 2 is, for example, a polyelectrolyte type fuel battery, having a stack structure in which a large number of fuel battery cells (hereinafter, also simply referred to as “cells”) 21 are stacked. The cell 21 has a cathode electrode (air electrode) on one side of an electrolyte formed of an ion exchange membrane and an anode electrode (fuel electrode) on the other side of the electrolyte. For the electrodes including the cathode electrode and the anode electrode, platinum Pt based on porous carbon material is used as a catalyst (electrode catalyst). Furthermore, the cell 21 has a pair of separators in such a way as to sandwich the cathode electrode and the anode electrode from both sides. In this case, a hydrogen gas is supplied to a hydrogen gas flow path of one separator, while an oxidizing gas is supplied to an oxidizing gas flow path of the other separator. A chemical reaction between these reactant gases generates electric power.

The fuel battery 2 is provided with a voltage sensor V which detects the output voltage of the fuel battery and a current sensor A which detects the output current of the fuel battery. Each cell 21 of the fuel battery 2 is provided with a cell monitor (a cell voltage detector) 170 which detects the voltage of the cell 21.

The oxidizing gas piping system 3 has a compressor 31 which compresses air taken through a filter and sends out the compressed air as an oxidizing gas, an oxidizing gas supply flow path 32 which supplies the oxidizing gas to the fuel battery 2, and an oxidizing off-gas discharge flow path 33 which discharges the oxidizing off-gas discharged from the fuel battery 2.

There is provided a flow rate sensor F, which measures the flow rate of the oxidation gas ejected from the compressor 31, on the outlet side of the compressor 31. The oxidizing off-gas discharge flow path 33 is provided with a back pressure valve 34 which adjusts the pressure of the oxidation gas in the fuel battery 2. On the outlet-side of the fuel battery 2 in the oxidizing off-gas discharge flow path 33, there is provided a pressure sensor P which detects the pressure of the oxidation gas in the fuel battery 2.

The fuel gas piping system 4 has a fuel tank 40 as a fuel supply source which stores a high-pressure fuel gas, a fuel gas supply flow path 41 for supplying the fuel gas of the fuel tank 40 to the fuel battery 2, and a fuel circulation flow path 42 for returning the fuel off-gas discharged from the fuel battery 2 to the fuel gas supply flow path 41. The fuel gas supply flow path 41 is provided with a regulating valve 43 which adjusts the pressure of the fuel gas to a preset secondary pressure. The fuel circulation flow path 42 is provided with a fuel pump 44 which pressurizes the fuel off-gas in the fuel circulation flow path 42 and sends the pressurized fuel off-gas out to the fuel gas supply flow path 41 side.

The cooling system 5 has a radiator 51 which cools down cooling water, a cooling water circulation flow path 52 which supplies the cooling water to the fuel battery 2 and the radiator 51 in a circulating manner, and a cooling water circulation pump 53 which circulates the cooling water into the cooling water circulation flow path 52. The radiator 51 is provided with a radiator fan 54. On the outlet side of the fuel battery 2 in the cooling water circulation flow path 52, there is provided a temperature sensor T for detecting the temperature of the cooling water. The position where the temperature sensor T is provided may be on the inlet side of the fuel battery 2.

The electric power system 6 has a DC-DC converter 61, a battery 62 as a secondary battery, a traction inverter 63, a traction motor 64 as a power consumption device, and various auxiliary inverters and the like not illustrated. The DC-DC converter 61, which is a direct-current voltage converter, has a function of adjusting the DC voltage input from the battery 62 and outputting the adjusted DC voltage to the traction inverter 63 side and a function of adjusting the DC voltage input from the fuel battery 2 or the traction motor 64 and outputting the adjusted DC voltage to the battery 62. These functions of the DC-DC converter 61 enable the charging and discharging of the battery 62.

In the battery 62, battery cells are stacked with a constant high voltage as a terminal voltage and the control of a battery computer, which is not illustrated, enables charging with surplus electric power or auxiliary supply of electric power. The traction inverter 63 converts the DC current into a three-phase alternating current and supplies the converted current to the traction motor 64. The traction motor 64 is, for example, a three-phase AC motor and constitutes the main power source of a fuel cell hybrid vehicle equipped with the fuel cell system 1. The auxiliary inverter, which is a motor control unit for controlling the drive of each motor, converts the DC current into a three-phase alternating current and supplies the converted current to each motor.

Moreover, the fuel battery 2 is connected to a cell monitor (output voltage sensor) 170 which measures a voltage for each cell 21. The installation form of the cell monitor 170 is not particularly limited. For example, if the total number of cells is 200, each cell 21 may be provided with a cell voltage terminal, one cell voltage terminal may be provided for a plurality of cells 21, or both may be mixed. In one example, the cell monitor 170 in which a cell voltage terminal is installed for each cell 21 is able to monitor the cell voltage for each cell and to monitor the total voltage of the fuel battery 2 by summing up the voltage monitored for each cell.

The control unit 7 measures the operation amount of an accelerating operation member (for example, an accelerator) provided in the fuel cell hybrid vehicle and receives control information such as an acceleration request value (for example, an amount of power generation required from a power consumption device such as the traction motor 64) to control the operation of various kinds of equipment in the system. The power consumption device includes not only the traction motor 64 but also, for example, an auxiliary device (for example, the motor or the like of a compressor 31, a fuel pump 44, or a cooling water circulation pump 53) necessary for bringing the fuel battery 2 into operation, an actuator used in various devices (a transmission, a wheel control device, a steering device, a suspension device, etc.) involved in the running of the vehicle, an air conditioner for an occupant space, a lighting device, an audio device and the like.

The control unit 7 physically has, for example, a CPU, a memory, and an input-output interface. The memory includes, for example, a ROM for storing control programs and control data processed by the CPU and a RAM used as various work areas mainly for control processing. These elements are connected to each other via a bus. The input-output interface is connected to various sensors such as a voltage sensor V, a current sensor A, a pressure sensor P, a temperature sensor T, and a flow rate sensor F and is connected to various drivers for driving the compressor 31, the fuel pump 44, the cooling water circulation pump 53, and the like.

The CPU receives measurement results in various sensors via the input-output interface according to the control programs stored in the ROM and performs processing by using various data or the like in the RAM to perform various kinds of control processing. Moreover, the CPU controls the entire fuel cell system 1 by outputting control signals to various drivers via the input-output interface. Hereinafter, description will be made on a water-containing state determination process performed by the control unit 7 in the first embodiment. The water-containing state determination process in the first embodiment is performed during a normal operation. The operating state of the fuel battery includes a normal operation and an intermittent operation. The intermittent operation is an operation mode for running a fuel cell hybrid vehicle only by the electric power supplied from the battery 62 and the normal operation is an operation mode for operations other than the intermittent operation.

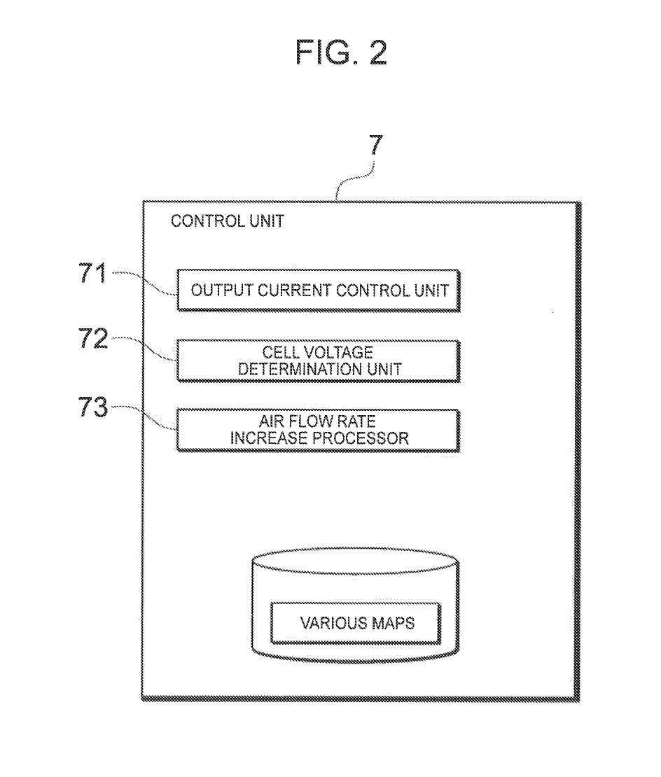

As illustrated in FIG. 2, the control unit 7 has an output current control unit 71 (output current control means), a cell voltage determination unit 72, and an air flow rate increase processor (water content difference reduction means) 73 in terms of function.

The output current control unit 71 temporarily increases the output current of the fuel battery 2.

The cell voltage determination unit 72 determines whether a difference between the average voltage and the minimum cell voltage Vb, which has been detected by the cell monitor, has reached a predetermined threshold value or greater.

The output current control unit 71 performs power generation of the threshold value or greater in order to reduce the water content difference in the fuel battery 2 if the cell voltage determination unit 72 determines that the foregoing voltage difference is equal to or greater than the threshold value.

The air flow rate increase processor 73 performs an increase process of the air flow rate in order to efficiently reduce the water content difference in the fuel battery 2 in synchronization with the increase in the amount of power generation if the cell voltage determination unit 72 determines that the foregoing voltage difference is equal to or greater than the threshold value.

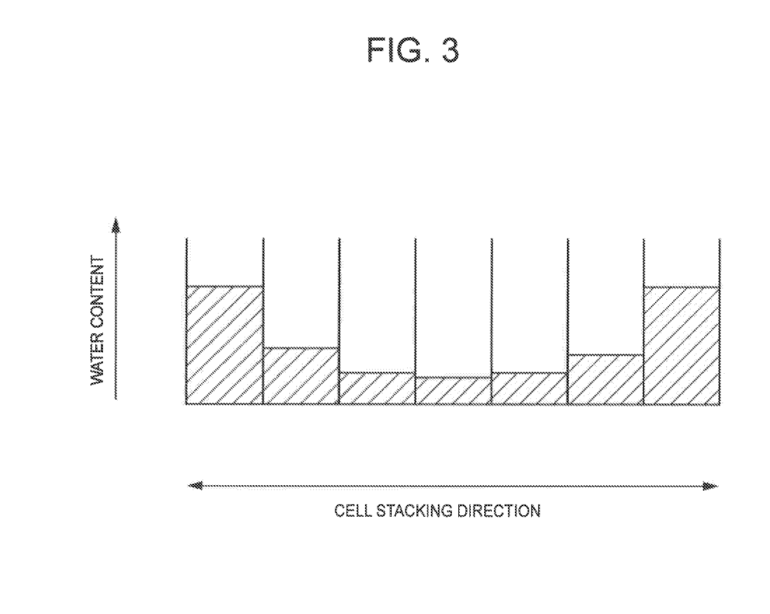

Subsequently, description will be made on a cell voltage recovery process performed in the fuel cell system of this embodiment (See FIGS. 3 to 7). The fuel cell system 1 of this embodiment performs the cell voltage recovery process when predetermined conditions are satisfied by the control unit 7 which functions as cell voltage drop detection means and cell voltage recovery means.

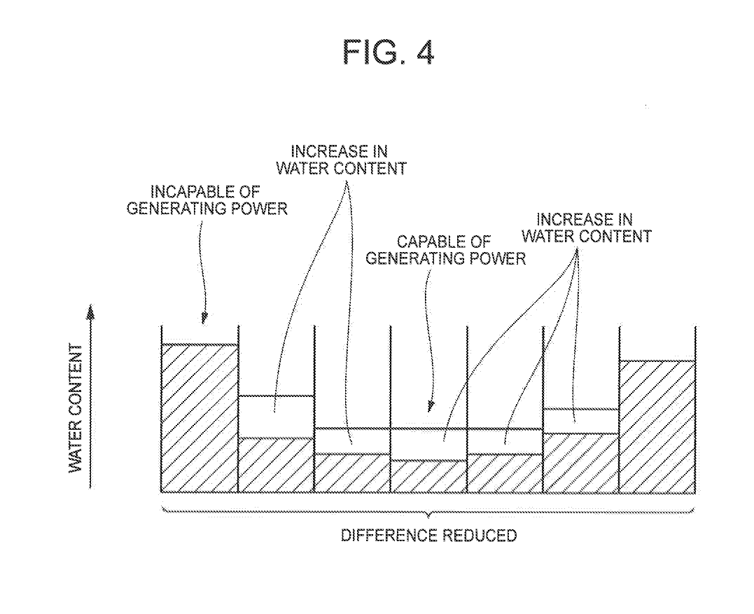

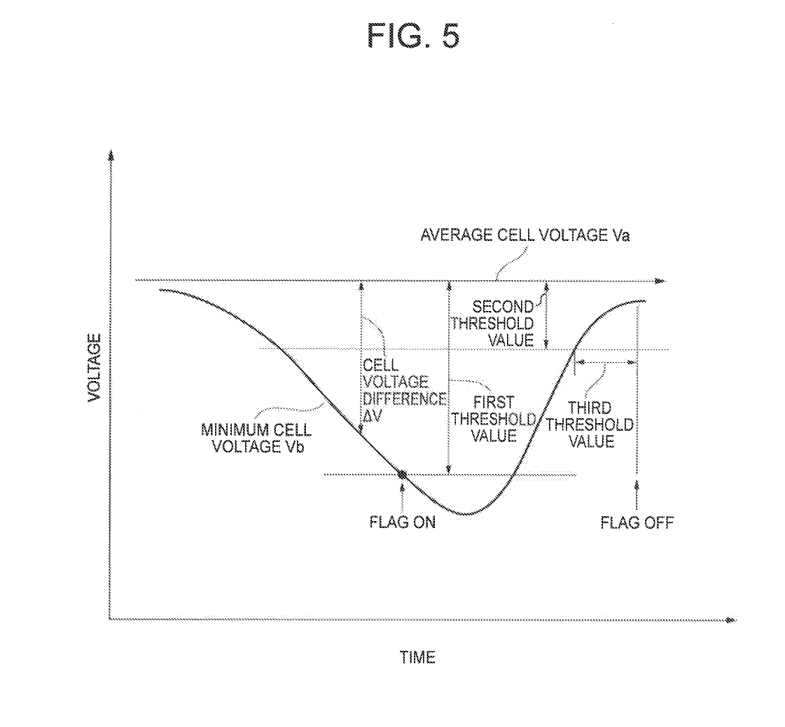

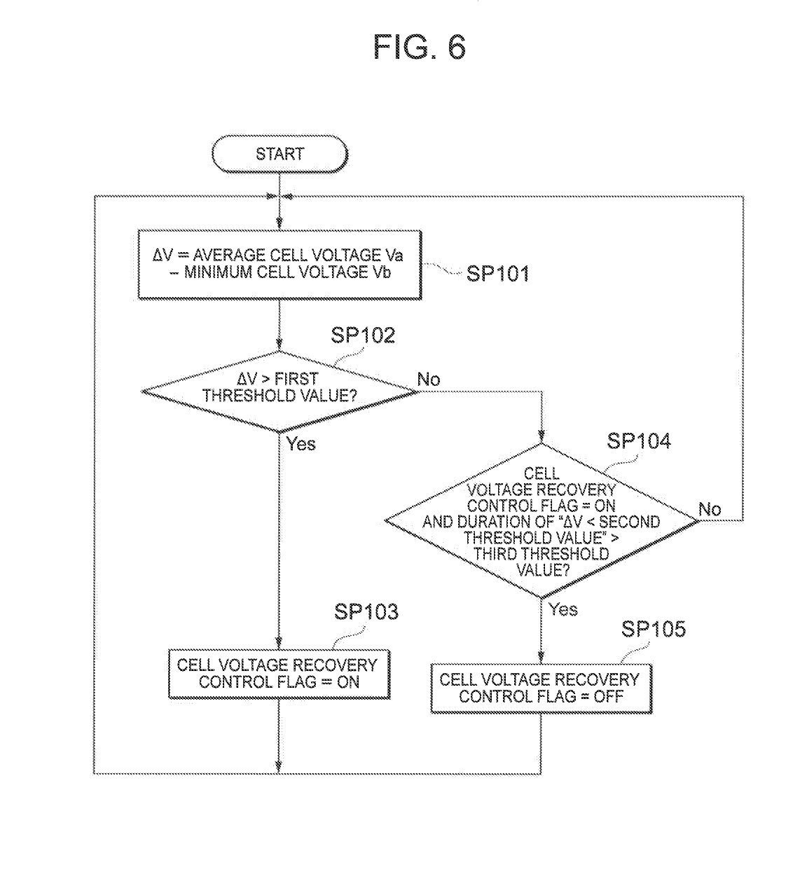

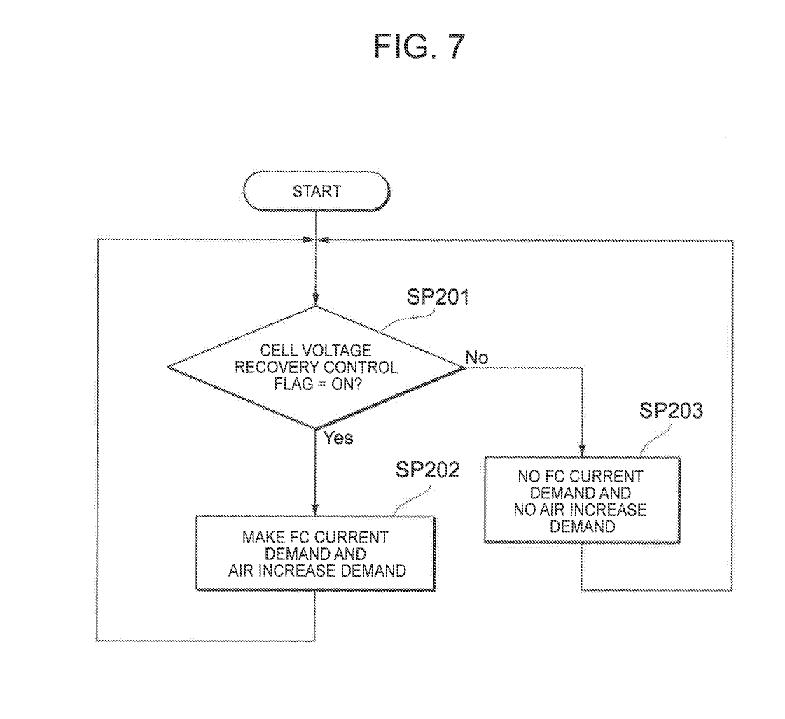

FIG. 3 is a diagram illustrating an outline of a state where a large difference is observed in water content between stacked cells. FIG. 4 is a diagram illustrating an outline of water contents in the cells after the cell voltage recovery process according to this embodiment. FIG. 5 is a graph illustrating an average cell voltage Va, a minimum cell voltage Vb, threshold values, and the like in the cell voltage recovery process. FIG. 6 is a first flowchart illustrating an example of the cell voltage recovery process and FIG. 7 is a second flowchart illustrating an example of the cell voltage recovery process. The cell voltage recovery processes illustrated in FIGS. 6 and 7 are executable in parallel with each other. For example, the cell voltage recovery processes are started when an ignition key is turned on and performed repeatedly until the operation ends.

The control unit 7 first calculates a difference between the average value (average cell voltage Va) and the minimum cell voltage Vb of the cell voltages detected by the cell monitor 170 according to the processing flow illustrated in FIG. 6 and considers the calculated difference as a cell voltage difference ΔV (step SP101). Subsequently, the control unit 7 determines whether the cell voltage difference ΔV exceeds the first threshold value (step SP102). The first threshold value is a value satisfying a condition (first condition) that a difference between the water content of some cells 21 and the water content of other cells 21 is larger than a predetermined value. The details are as described below.

Specifically, end cells (a plurality of cells located at both ends in the cell stacking direction) 21 of a fuel battery stack formed of a plurality of stacked cells 21 are apt to get cold by heat dissipation and therefore water is easily condensed and cell water contents are apt to increase (see FIG. 3). If the cell water content increases to be excessive, the cell voltage drops. Moreover, the increase in the cell water content causes a high pressure loss and therefore it is difficult to sufficiently discharge water, which has been excessively accumulated in the end cells 21, even by means of air blow, and not only that, air flows into cells in which the discharge of water is less required (in other words, the central cells whose water contents are normal or less than the normal amount), by which water is excessively discharged and the cells are easily dried in some cases. For this reason, in this embodiment, the first threshold value is defined to be a voltage difference falling under the condition (first condition) that a difference between the water content of some cells 21 and the water content of other cells 21 is greater than a predetermined value (see FIG. 5). As apparent from the illustration of FIG. 5, the first threshold value described in this specification is represented by a voltage width (the magnitude of voltage difference with the average cell voltage Va as a reference) (the same applies to “second threshold value” described later). For example, the magnitude of the first threshold value is 0.2 V, but that is merely illustrative and can be set accordingly.

If the cell voltage difference ΔV exceeds the first threshold value (Yes in step SP102), the control unit 7 sets a cell voltage recovery control flag (step SP103) and returns to step SP101 to repeat the process (see FIG. 6).

Moreover, the control unit 7 determines whether the cell voltage recovery control flag is set according to another processing flow (see FIG. 7) performed in parallel with the foregoing processing flow (FIG. 6) (step SP201). If the flag is set, the control unit 7 functions as cell voltage recovery means and makes an FC current demand to cause the fuel battery 2 to perform surplus power generation (current sweep) and makes an increase demand of an air amount of the air blow (step SP202). Meanwhile, unless the cell voltage recovery control flag is set, the control unit 7 makes neither of the FC current demand and the air increase demand and returns to step SP201 to repeat the process (step SP203).

When the control unit 7 makes the FC current demand and causes the fuel battery 2 to perform the surplus power generation, water is generated by the power generation, thereby decreasing the difference in water content between the cells (see FIG. 4). Specifically, the pressure loss difference between the cells 21 reduces. Therefore, an increase in the air amount of air blow in this state enables water to be discharged efficiently. If water is able to be discharged efficiently, the minimum cell voltage Vb, which has dropped due to an influence of the increase in the water content, quickly rises (see FIG. 5).

Moreover, the control unit 7 continues to repeatedly determine whether the cell voltage difference ΔV exceeds the first threshold value along the flow illustrated in FIG. 6 (step SP102). If the cell voltage difference ΔV decreases to the first threshold value or less (No in step SP102) along with the increase in the minimum cell voltage Vb, the control unit 7 determines whether both of the following conditions are satisfied: the cell voltage recovery control flag=ON; and the duration of “ΔV<a second threshold value”>a third threshold value (step SP104).

In this regard, the second threshold value is set to a voltage width (the magnitude of a voltage difference with the average cell voltage Va as a reference) smaller than the width of the foregoing first threshold value (see FIG. 5). The third threshold value is used to decide whether to finish the cell voltage recovery control flag and represents a predetermined time period after the time when the state satisfying “ΔV<the second threshold value” is achieved. If both of the following conditions are satisfied: the cell voltage recovery control flag=ON; and the duration of “ΔV<the second threshold value”>the third threshold value (Yes in step SP104), the control unit 7 sets off the cell voltage recovery control flag (step SP105). The surplus power generation is stopped as necessary by setting off the cell voltage recovery control flag if the conditions of step SP104 are satisfied in this manner, thereby enabling the suppression of wasteful power generation after the completion of the voltage recovery process.

On the other hand, unless both of the following conditions are satisfied: the cell voltage recovery control flag=ON; and the duration of “ΔV<the second threshold value”>the third threshold value (No in step SP104), the control unit 7 returns to step SP101 to repeat the process. Moreover, after setting off the cell voltage recovery control flag in step SP105, the control unit 7 also returns to step SP101 to repeat the process (see FIG. 6).

As described hereinabove, in this embodiment, it is possible to achieve an effect of reducing the water content difference and a purge effect only by increasing the amount of power generation (for example, 50 A×10 seconds) at the time of voltage drop in some cells 21 (the voltage drop in the cells 21 easily occurs particularly at low load [for example, at output 10 to 20 A], which occurs because the fluid is not pushed into the cells 21 at the air flow rate during low load relative to the pressure loss increased by an increase in the water content). More specifically, water is generated by surplus power generation of the fuel battery 2 to increase the water content of the central cells 21 contributing to the power generation in order to reduce the water content difference between the central cells 21 and the end cells 21 originally having high water content, thereby reducing the pressure loss difference and causing a state where water is easily discharged. Water is efficiently discharged in this state, thereby enabling the dropped cell voltage to be recovered.

Although the foregoing embodiment is merely an example of a preferred embodiment of the present disclosure, the present disclosure is not limited thereto and various modifications or alterations to the present disclosure may be made within the spirit and scope of the present disclosure. For example, in the present embodiment, a voltage drop of the fuel battery 2 is detected by using the average value of the cell voltages (average cell voltage Va) detected by the cell monitor 170 and the minimum cell voltage Vb. It is, however, also possible to use other means such as, for example, means of predicting the voltage drop by calculating the water contents of the cells 21. In the foregoing fuel cell system 1, it is possible to calculate the water contents by using the function of the control unit 7 which determines the water-containing state with reference to various maps to predict the voltage drop in the fuel battery 2 from a difference (deviation) of the water contents. In this case, the foregoing first condition may be that a difference between the water content of the end cells and the water content of the central cells obtained by the calculation is larger than a predetermined value.

Moreover, the foregoing embodiment has been described with the plurality of cells located at both ends or in the vicinity thereof in the cell stacking direction of the fuel battery 2 referred to as “end cells” and with the rest of the cells referred to as “central cells.” These terms have been used for convenience since the cells in the vicinity of the ends are apt to have high water content while the cells away from the ends and closer to the center are apt to have low water content. Therefore, these terms are not intended to clarify the boundary between them. It is apparent from the contents of the above description of, for example, detecting a voltage drop of the fuel battery 2 from the average cell voltage Va and the minimum cell voltage Vb and it is unnecessary to define the specific details of the end cells and the central cells.

According to the present disclosure, a dropped voltage is able to be recovered by sufficiently discharging water even in the case where a water content difference is large between stacked cells and air is hardly flows in some of the cells.

The present disclosure is suitably applied to a fuel cell system which generates electric power by causing the hydrogen gas and the oxidation gas to react with each other.

What is claimed is:

1. A fuel cell system including a fuel battery composed of a plurality of cells, the fuel cell system comprising cell voltage recovery unit configured to increase an amount of power generation in the case where a difference in water content between some and others of the cells is greater than a predetermined value.

2. The fuel cell system according to claim 1, wherein the cell voltage recovery unit configured to cause the fuel battery to perform operation in which the amount of power generation exceeds that in the normal operation in the case where a first condition is satisfied such that the difference in water content between some and others of the cells is greater than the predetermined value.

3. The fuel cell system according to claim 2, wherein the first condition is that a cell voltage difference ΔV, which is a difference between an average cell voltage Va and a minimum cell voltage Vb, is greater than a first threshold value.

4. The fuel cell system according to claim 3, wherein the cell voltage recovery unit configured to stop cell voltage recovery control in the case where the cell voltage difference ΔV between the average cell voltage Va and the minimum cell voltage Vb decreases to the first threshold value or less after satisfying the first condition and then a state where the cell voltage difference ΔV is smaller than a second threshold value, which is smaller than the first threshold value, has continued for a predetermined time or longer.

5. The fuel cell system according to claim 2, wherein the first condition is that a difference in water content between end cells and central cells obtained by calculation is greater than a predetermined value.

6. The fuel cell system according to claim 1, wherein the cell voltage recovery unit configured to increases the flow rate of the oxidation gas in synchronization with increasing the amount of power generation.

7. The fuel cell system according to claim 2, wherein the cell voltage recovery unit configured to increases the flow rate of the oxidation gas in synchronization with increasing the amount of power generation.

8. The fuel cell system according to claim 3, wherein the cell voltage recovery unit configured to increases the flow rate of the oxidation gas in synchronization with increasing the amount of power generation.

9. The fuel cell system according to claim 4, wherein the cell voltage recovery unit configured to increases the flow rate of the oxidation gas in synchronization with increasing the amount of power generation.

10. The fuel cell system according to claim 5, wherein the cell voltage recovery unit configured to increases the flow rate of the oxidation gas in synchronization with increasing the amount of power generation.

11. A method of recovering a cell voltage of a fuel cell system including a fuel battery composed of a plurality of cells, comprising the step of increasing an amount of power generation in the case where a difference in water content between some and others of the cells is greater than a predetermined value.

12. The method of recovering the cell voltage of the fuel cell system according to claim 11, wherein the fuel battery is caused to perform operation in which the amount of power generation exceeds that in the normal operation in the case where a first condition is satisfied such that the difference in water content between some and others of the cells is greater than the predetermined value to reduce a cell voltage difference ΔV between an average cell voltage Va and a minimum cell voltage Vb.

13. A fuel cell system comprising:
a fuel cell which has a plurality of cells;
a cell monitor which detects cell voltage of the cells; and
a control device, wherein the control device comprises:
a cell voltage determination unit configured to determine whether a voltage difference between an average voltage of the cells and a minimum cell voltage Vb of the cells, which has been detected by the cell monitor, has reached a predetermined threshold value or greater;
an output current control unit configured to perform power generation of a predetermined value or greater so that a water content difference between the cells is reduced in the case where the cell voltage determination unit determines that the voltage difference between the average voltage of the cells and the minimum cell voltage Vb of the cells is equal to or greater than the predetermined threshold value; and
an air flow rate increase processor unit configured to perform an increase process of the air flow rate of the fuel cell so that the water content difference between the cells in synchronization with an increase in power generation is reduced in a case where the cell voltage determination unit determines that the voltage difference between the average voltage of the cells and the minimum cell voltage Vb of the cells is equal to or greater than the predetermined threshold value.
